(19) United States
(12) Patent Application Publication
(10) Pub. No.: US 2004/0207250 A1
(43) Pub. Date: Oct. 21, 2004

(54) Hydraulic reservoir, braking device comprising such a reservoir and method of mounting the said reservoir

(76) Inventors: Regis Porchet, Boussy Saint Antoine (FR); Emmanuel Fraisse, Paris (FR)

Correspondence Address: Leo H McCormick Jr, Bosch Braking Systems, 2112 Mishawaka Avenue, PO Box 4721, South Bend, IN, 46634-4721, US

(21) Appl. No.: 10/487,365

(22) PCT Filed: Jun. 19, 2002
(86) PCT No.: PCT/FR02/02112

(30) Foreign Application Priority Data
Jun. 21, 2001 (FR) 01/08302

(51) Int. Cl. B60T 17/00

(52) U.S. Cl. 303/1

(57) ABSTRACT

The present invention relates mainly to a hydraulic reservoir, to a braking device comprising such a reservoir and to a method for mounting the said reservoir. A reservoir according to the present invention comprises a first (1) and a second (3) piece which are connected in a sealed manner by connecting means (10, 15), and a filling orifice (5) and at least one outlet orifice (19, 21). The device according to the present invention comprises a master cylinder (31) equipped with the reservoir according to the present invention. The mounting method comprises the steps of:

mounting the second piece (3) on the master cylinder (31); and

connecting the first piece (1) to the second piece (3) fixed to the master cylinder (31).

The present invention relates mainly to a hydraulic reservoir, particularly a brake fluid reservoir, to a braking device comprising such a reservoir and to a method for mounting the said reservoir.

Hydraulic reservoirs used for braking devices are generally made as a single piece comprising a filling orifice and at least one flow orifice, the filling orifice and the flow orifice being able possibly to be the same orifice. This type of reservoir is fixed to a master cylinder, particularly a tandem master cylinder that distributes the brake fluid to the wheels of the vehicle; the reservoir advantageously and independently feeds first and second hydraulic circuits.

New braking devices comprise antilock braking systems, and vehicle dynamic stability control systems which, to operate, require a great deal of brake fluid, and therefore brake fluid reservoirs of significant volume, something which poses problems of space occupancy when mounting them.

In general, one-piece reservoirs are supplied to the motor manufacturers already mounted on the master cylinders. However, because the engine compartment is so crowded and there is so little space left for the braking device, mounting the master cylinder equipped with the reservoir is becoming increasingly complex.

There are also hydraulic reservoirs comprising a small-volume first reservoir fixed to the master cylinder and a large-capacity second reservoir connected to the first reservoir by a pipe, the second reservoir being arranged in an accessible part of the engine compartment so as to allow it to be filed and so as to allow the visual check of the level of brake fluid.

This makes it possible to have the greater capacity of brake fluid available in part of the engine compartment where there is more space. This type of reservoir does, however, also pose problems when mounting the pipe that connects the two reservoirs, because of the lack of access to the first reservoir fixed to the master cylinder.

In addition, certain motor manufacturers no longer wish to take delivery of the reservoirs independently, as this increases stock management costs on the procurement side. However, it is hardly conceivable for motor manufacturers to be supplied a complete ready-mounted assembly comprising the two-part reservoir with the two parts connected by a pipe mounted on the master cylinder, because this would prove to be too bulky for mounting, and as the master cylinder is often mounted from the interior of the vehicle, this dictates that the assembly should be even less bulky.

In addition, in order to be able to make a visual check of the level of brake fluid in the reservoir and if necessary to fill the reservoir, the upper part of the reservoir and the filling orifice need to be readily accessible.

It is therefore an object of the present invention to offer a reservoir which can be mounted in the engine compartment in a simple way.

Another object of the present invention is to offer a reservoir of a shape tailored to the space available in the engine compartment.

Another object of the present invention is to offer a reservoir comprising a low number of parts.

Another object of the present invention is to offer a braking device which can be installed quickly in the engine compartment.

Another object of the present invention is to offer a braking device in which filling with brake fluid and performing the visual check on the level to which the brake fluid has been filled are easier.

These objects are achieved by a reservoir according to the present invention comprising complementing first and second pieces forming a rigid one-piece reservoir the second part of which comes mounted on the master cylinder.

In other words, this is a two-part reservoir, a first part is equipped with an inlet orifice and with an outlet orifice and a second part comprises an inlet orifice and at least one outlet orifice, the outlet orifice of the first part collaborating with the inlet orifice of the second part in order to form a hermetic rigid one-piece reservoir, the second part being supplied mounted on the master cylinder.

The present invention advantageously makes it possible to supply a reservoir which can be mounted without the need for special tools.

The subject of the present invention is therefore a hydraulic fluid reservoir comprising a first and a second rigid piece defining a first and a second volume, the first piece being equipped in its upper part with an inlet orifice equipped with a shut-off means, with an outlet orifice and with first connecting means able to collaborate with second connecting means belonging to the second piece, the second piece being equipped in its lower part with an inlet orifice, with at least one outlet orifice and with the second connecting means, the said reservoir also comprising a sealing means collaborating with the connecting means, characterized in that fixing the first piece on the second piece using the connecting means forms a rigid one-piece reservoir.

Another subject of the present invention is a reservoir, characterized in that the first connecting means of the first piece comprises a first sleeve of smaller diameter bordering the outlet orifice of the first piece, of an inside diameter equal to the diameter of the outlet orifice and extending towards the inside of the first piece, and a second sleeve of larger diameter, with an inside diameter greater than the diameter of the outlet orifice extending towards the outside of the first piece, and in that the second connecting means of the second piece comprise a first sleeve of smaller diameter, with an outside diameter equal to the inside diameter of the smaller-diameter first sleeve of the first piece, bordering the inlet orifice of the second piece and extending towards the outside of the said second piece and a second sleeve of larger diameter, with an outside diameter equal to the inside diameter of the larger-diameter second sleeve of the first piece, surrounding the smaller-diameter sleeve of the second piece.

Another subject of the present invention is a reservoir, characterized in that the larger-diameter second sleeve of the second piece connects via its outer periphery to the smaller-diameter first sleeve of the second piece along a generatrix of the said first and second sleeves.

Another subject of the present invention is a reservoir, characterized in that the larger-diameter second sleeve of the second piece has the shape of a wide ring surrounding the smaller-diameter first sleeve of the second piece.

Another subject of the present invention is a reservoir, characterized in that the said first and second sleeves of the first piece are formed integrally with the first piece, and in that the first and second sleeves of the second piece are formed integrally with the second piece.

Another subject of the present invention is a reservoir, characterized in that the first piece is connected to the second piece by snap-fastening.

Another subject of the present invention is a reservoir, characterized in that the first and second pieces are snap-fastened together and form a reservoir that is hermetic except at the sites of the filling and outlet orifices.

Another subject of the present invention is a reservoir, characterized in that the first and second pieces are made of transparent plastic.

Another subject of the present invention is a braking device comprising a master cylinder, characterized in that the second piece is mounted on the said master cylinder.

Another subject of the present invention is a braking device, characterized in that it comprises the reservoir according to the present invention.

Another subject of the present invention is a method of mounting in a vehicle engine compartment, characterized in that it comprises, inter alia:

a first step of mounting the master cylinder equipped with the second piece in a vehicle engine compartment;

a second step of fixing the first piece to the second piece by pushing the first and second sleeves of the second piece into the respective first and second sleeves of the first piece.

Another subject of the present invention is a mounting method, characterized in that it also comprises, after the first step of mounting, the step of unhooking the first piece from the braking device.

The present invention will be better understood by means of the description that follows and of the appended figures which are given by way of non-limiting example and in which:

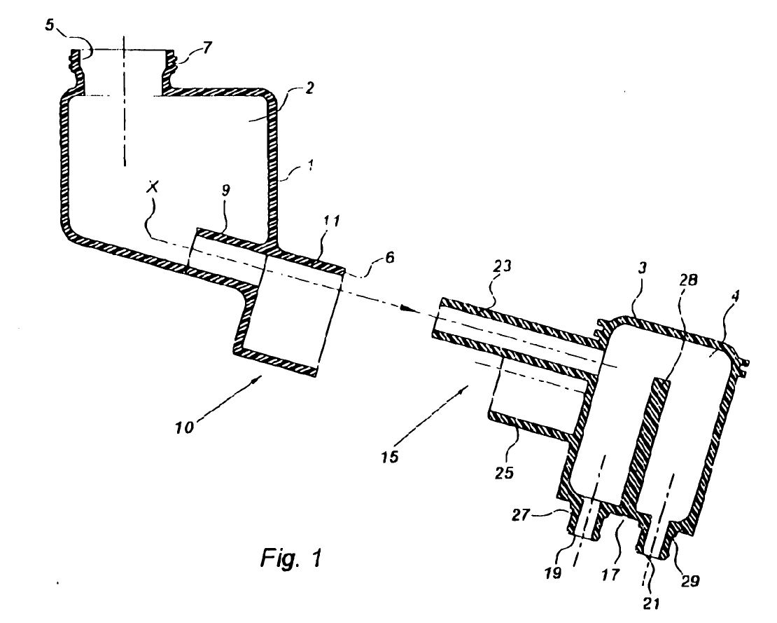

FIG. 1 is a view in cross section of a first embodiment of a two-part reservoir prior to mounting according to the present invention,

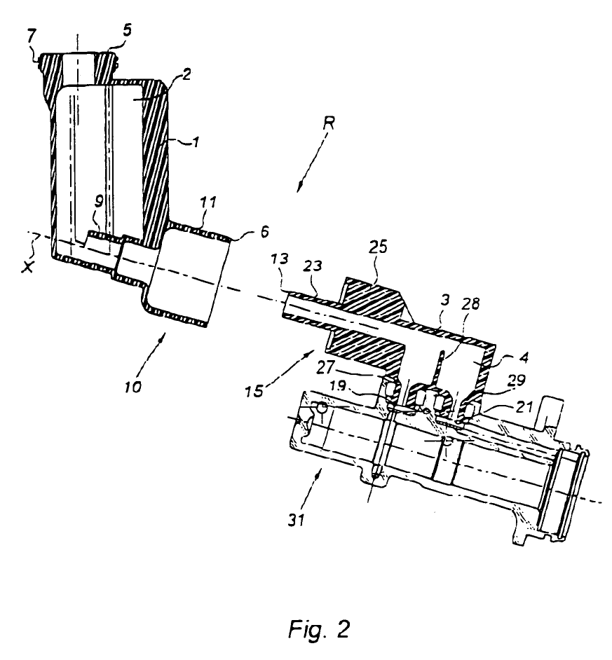

FIG. 2 is a view in cross section of a second embodiment of a reservoir prior to mounting according to the present invention and of a master cylinder prior to the definitive mounting of the reservoir on the master cylinder.

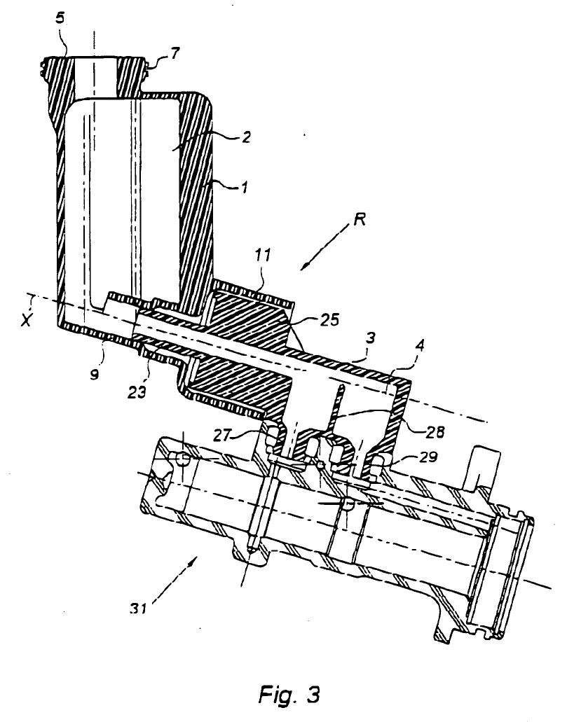

FIG. 3 is a view in cross section of the reservoir/master cylinder assembly of FIG. 2, after definitive mounting.

FIG. 1 shows a reservoir R according to the present invention prior to mounting, comprising a first piece 1 defining a first volume 2 and a second piece 3 defining a second volume 4. Piece 1 in its upper part comprises a filling orifice 5 and in its lower part comprises a flow orifice 6, piece 1 being rigid and hermetic except at the orifices 5, 6. The filling orifice is extended towards the outside by a sleeve 7 formed integrally with the piece 1, the sleeve 7 being able to collaborate with a shut-off means (not depicted), for example a cap, advantageously screw-fastened onto the exterior periphery of the sleeve 7. The piece 1 advantageously comprises, in its upper part, a very small-diameter orifice (not depicted) allowing the air contained in the volume 2 to be placed at atmospheric pressure so as to avoid any depression phenomenon that would impede the flow of fluid, the vent orifice is advantageously made in the shut-off means of the filling orifice 5. The piece 1 also comprises, in its lower part, connecting means 10 able to collaborate with connecting means belonging to the second piece 3. The connecting means 10 comprise a smaller-diameter first sleeve 9 surrounding the orifice 6 and having an inside diameter equal to the diameter of the orifice 6 and of axis X extending the piece 1 inwards into the volume 2, and a larger-diameter second sleeve 11 surrounding the orifice 6 with an inside diameter greater than the diameter of the orifice 6, extending the first piece 1 outwards and of an axis parallel to the axis X, the smaller-diameter sleeve 9 and the larger-diameter sleeve 11 being formed integrally with the piece 1. The lower wall of the piece 1 is advantageously inclined towards the flow orifice 6.

The piece 1 advantageously comprises catching means (not depicted) for hooking it to a braking device, for example a brake booster.

The piece 3 in its upper part comprises an inlet orifice 13 and connecting means 15 and in its lower part comprises at least one outlet orifice, advantageously two outlet orifices 19, 21, formed in a bottom face 17 and each able to collaborate with a hydraulic chamber of a tandem master cylinder, the piece 13 being rigid and hermetic except at the site of the inlet 13 and outlet 19, 21 orifices.

The connecting means 15 extend around the orifice 13 towards the outside of the piece 4 in the form of a smaller-diameter first sleeve 23 of axis X and of outside diameter roughly equal to the inside diameter of the smaller-diameter sleeve 9 and long enough to enter the sleeve 9 when the piece 1 and the piece 3 are assembled. The connecting means 15 also comprise a larger-diameter second sleeve 25 coaxial with the axis of the second sleeve 11, surrounding the smaller-diameter first sleeve 23 and of an outside diameter equal to the inside diameter of the sleeve 11.

In the first embodiment depicted in FIG. 1, the first and second sleeves 23, 25 connect longitudinally along the axis X in their upper parts. In the second embodiment depicted in FIG. 2, the larger-diameter second sleeve 25 is coaxial with the smaller-diameter first sleeve 23 and has roughly the shape of a very thick ring surrounding the sleeve 23 and formed integrally with the smaller-diameter first sleeve 23. The outlet orifices 19 and 21 extend respectively outwards from the second piece 3 in the form of sleeves 27, 29 able to collaborate in a sealed manner with supply orifices of a first and second hydraulic circuit of a tandem master cylinder.

The lower part of the interior volume 4 of the piece 3 is advantageously divided over a certain height by a partition 28 extending towards the upper part of the piece 3 of the end wall of the piece 3 between the first and second outlet orifices 19 and 21 up to a certain height on the piece 3, into a first and second capacity which are distinct, sealed in their lower part, and each respectively equipped in their lower part with the first and second outlet orifices 19 and 21, each capacity independently feeding the first and second hydraulic circuits. The upper end of the partition 28 is situated at least below the upper part of the inlet orifice 13.

The partition 28 makes it possible, in the event of a leak in the first capacity and therefore failure of the hydraulic circuit fed by this first capacity, to have a supply of brake fluid to the second hydraulic circuit via the second capacity which is unaffected by the leak in the first capacity.

The pieces 1 and 3 are advantageously produced by moulding, advantageously in transparent plastic so that the level of brake fluid in the circuit can be checked.

The part 1 advantageously comprises, on its periphery, markings (not depicted) at least indicating the minimum fill level for brake fluid needed for correct operation of the braking circuit and, advantageously, the maximum fill level. The part 1 is advantageously equipped with a detector, advantageously an electrical one (not depicted), detecting the level of brake fluid and connected to a device alerting the driver to an excessively low brake fluid level, for example to an illuminated warning light arranged in the cabin of the vehicle.

We shall now describe the method the motor manufacturer uses to mount the complete reservoir R on the braking device depicted in FIGS. 2 and 3.

The manufacturer receives the braking device comprising at least one master cylinder 31, particularly a tandem master cylinder, on which the piece 3 is mounted, the master cylinder 31 is advantageously connected by its longitudinal end facing towards the brake pedal, to a brake booster (not depicted).

The mounting method comprises:

a first step A of fixing the master cylinder 31 equipped with the piece 3 inside the engine compartment of the vehicle;

a second step B of connecting the piece 1 to the piece 3 using the connecting means 10, 13 [sic] by causing the smaller-diameter sleeve 23 of the second piece 3 to enter the smaller-diameter sleeve 9 of the first piece 1 and causing the larger-diameter sleeve 25 of the second piece 3 to enter the larger-diameter sleeve 11 of the first piece 1, rigid fixing of the first piece 1 to the second piece 3 advantageously being by snap-fastening, sealing being achieved using sealing means (not depicted), for example O-rings.

The first piece 3 advantageously comes hooked to the braking device, for example to the booster, and a mounting method comprising a second step of unhooking the piece 3 from the braking device is therefore envisaged, the steps of which method are as follows:

a first step A of fixing the master cylinder 31 equipped with the piece 3 inside the engine compartment of the vehicle;

a second step B′ of unhooking the piece 1 from the brake booster;

a third step C′ of connecting the piece 1 to the piece 4 [sic] using the connecting means 10, 13 [sic] by causing the smaller-diameter sleeve 23 of the second piece 3 to enter the smaller-diameter sleeve 9 of the first piece 1 and causing the larger-diameter sleeve 25 of the second piece 3 to enter the larger-diameter sleeve 11 of the first piece 1, rigid fixing of the first piece 1 to the second piece 3 advantageously being by snap-fastening, sealing being achieved using sealing means (not depicted), for example O-rings.

When the piece 1 and the piece 3 are assembled using 30 one of the above methods, they form a one-piece reservoir that is rigid and hermetic except at the sites of the filling orifice 5 and of the outlet orifices 19 and 21.

This type of fixing advantageously allows rigid and sealed mechanical fixing without the use of special mounting tools.

Of course, reversing the connecting means 10 and 15 on the pieces 1 and 3 would not constitute a departure from the scope of the present invention.

Of course, a first piece and a second piece comprising any means of fixing the first piece to the second piece do not constitute a departure from the scope of the present invention.

Of course a reservoir according to the present invention having in its lower part just one outlet orifice feeding a single hydraulic circuit does not constitute a departure from the scope of the present invention.

The present invention applies mainly to the motor industry.

The present invention applies mainly to the industry of braking systems for vehicles, especially for private cars.

We claim:

1. A hydraulic fluid reservoir comprising a first and a second rigid piece (1, 3) defining a first and a second volume (2, 4), the first piece (1) being equipped in its upper part with an inlet orifice (5) equipped with a shut-off means, with an outlet orifice (6) and with first connecting means (10) able to collaborate with second connecting means (15) belonging to the second piece (3), the second piece (3) being equipped in its lower part with an inlet orifice (13), with at least one outlet orifice (19, 21) and with the second connecting means (15), the said reservoir also comprising a sealing means collaborating with the connecting means (10, 13), characterized in that fixing the first piece (1) on the second piece. (3) using the connecting means (10, 13) forms a rigid one-piece reservoir:

2. The hydraulic reservoir
according to claim 1, characterized in that the first connecting means (10) of the first piece (1) comprises a first sleeve (9) of smaller diameter bordering the outlet outlet orifice (6) of the first piece (1), of an inside diameter equal to the diameter of the outlet orifice (6) and extending towards the inside of the first piece (1), and a second sleeve (11) of larger diameter, with an inside diameter greater than the diameter of the outlet orifice (6) extending towards the outside of the first piece (1), and in that the second connecting means (15) of the second piece (3) comprise a first sleeve (23) of smaller diameter, with an outside diameter equal to the inside diameter of the smaller-diameter first sleeve (9) of the first piece (1), bordering the inlet orifice (13) of the second piece (3) and extending towards the outside of the said second piece (3) and a second sleeve (25) of larger diameter, with an outside diameter equal to the inside diameter of the larger-diameter second sleeve (11) of the first piece (1), surrounding the smaller-diameter sleeve (23) of the second piece (3).

3. The hydraulic reservoir according to claim 2, characterized in that the larger-diameter second sleeve (25) of the second piece (3) connects via its outer periphery to the smaller-diameter first sleeve (23) of the second piece (3) along a generatrix of the said first and second sleeves (23, 25).

4. The hydraulic reservoir according to claim 2, characterized in that the larger-diameter second sleeve (25) of the second piece (3) has the shape of a wide ring surrounding the smaller-diameter first sleeve (23) of the second piece (3).

5. The hydraulic reservoir according to claim 4, characterized in that the said first and second sleeves (9, 11) of the first piece (1) are formed integrally with the first piece (1), and in that the first and second sleeves (23, 25) of the second piece (3) are formed integrally with the second piece (3).

6. The hydraulic reservoir according to claim 5, characterized in that the first piece (1) is connected to the second piece (3) by snap-fastening.

7. The hydraulic reservoir according to claim 6, characterized in that the first and second pieces are snap-fastened together and form a reservoir that is hermetic except at the sites of the filling and outlet orifices.

8. The hydraulic reservoir according to claim 7, characterized in that the first and second pieces (1, 3) are made of transparent plastic.

9. The hydraulic reservoir according to claim 8 whereing the second piece (3) is mounted on the master cylinder (31).

10. The hydraulic reservoir according to claim 9, characterized in that it comprises a reservoir

11. The hydraulic reservoir according to claim 10 wherein it is mounted in a vehicle engine compartment, characterized in that it comprises, inter alia:
a first step (A) of mounting the master cylinder equipped with the second piece (3) in a vehicle engine compartment;
a second step (B) of fixing the first piece (1) to the second piece (3) by pushing the first and second sleeves (23, 25) of the second piece (3) into the respective first and second sleeves (9, 11) of the first piece (1).

12. The hydraulic reservoir according to claim 11, characterized in that it also comprises, after the first step (A), the step of unhooking the first piece (1) from the braking device.
